(19) United States
(12) Patent Application Publication
(10) Pub. No.: US 2023/0120109 A1
(43) Pub. Date: Apr. 20, 2023

(54) Magnetic Sunglass Car Air Vent Mount

(71) Applicant: Abdullah Rahmani, Lakeside, CA (US)

(72) Inventor: Abdullah Rahmani, Lakeside, CA (US)

(21) Appl. No.: 17/501,807

(22) Filed: Oct. 14, 2021

(51) Int. Cl. B60R 7/08; B60R 7/04

(52) U.S. Cl. CPC B60R 7/082; B60R 7/04; B60R 2011/0008

(57) ABSTRACT

A vehicle glasses receptacle arrangement which provides an advanced approach for storage of polarized glasses. Conventional cars have a problem that the glasses are damaged because they are stored together with other things in the dashboard box or console box. The present invention solves this by providing simple configuration of two parts which can be attached to glasses and vehicle's air vent and both parts are either magnetic or metallic in nature.

### BACKGROUND

### Field of the Invention

The present invention relates to a sunglass's storage mechanism in any vehicle and more particularly enables any polarized sunglasses to be stored/mounted in any vehicle's dashboard air vent grill using magnets on the bridge of the sunglass and a magnetic mount.

### Description of the Related Art

Eyeglasses have been used for many years and for various purposes, including as prescription eyeglasses, sunglasses, reading glasses, 3D glasses, glasses with magnifying lenses, safety glasses, stylistic glasses, etc.

The use of sunglasses has become more prevalent over the years. Sunglasses are recognized as useful for the protection of the eyes against ultraviolet rays. In fashion, new designs and colors have made them increasingly attractive as part of a person's overall wardrobe. In outdoor sports and outdoor activities, they have gained increasing acceptance. in certain sports, bicycling for example, specially designed sport sunglasses have gone from the exception to standard equipment.

Drivers of automobiles frequently find it necessary to change the eyeglasses they are wearing, or to put on sunglasses, Many drivers have a pair that they use especially for the distance vision involved in driving, and wear these only when they are behind the steering wheel. The change from one pair to another usually involves stuffing one pair into a convenient pocket, and pulling out the other either from another pocket, or from some storage location. When in a hurry, this is often clone as a one handed operation while the car is in motion. Obviously, the storage position of the glasses should be in a fixed place easily within reach from the driver's position. It should not be necessary to take the eyes off the road during this maneuver. The same problem arises in the use of sunglasses. The driver often does not realize he needs them until making a turn and finding the sun directly in his eyes.

Storage locations for the eyeglasses that are not momentarily in use have included loose placement on the flat area above the dashboard, in the glove compartment, drawers, and the various compartments that are customarily provided between the front seats of an automobile. None of these give the ready accessibility that is required for a one-handed change operation that does not require the driver to take his attention from the road. Some eyeglasses and sunglasses are stored on the visor above the steering wheel, and it is extremely difficult to manipulate eyeglasses in this position without distraction.

The instant invention attempts to overcome deficiencies of the prior art by providing an inexpensive arrangement that will function as a storage receptacle for eyeglasses, and capable of installation on practically any vehicle

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to an advancement in offering storage arrangement for polarized glasses in any type of vehicle.

It is further the objective of the invention to create a safe, durable, and easy to use mount with magnets and are attached to dashboard's air vent grill.

It is moreover the objective of the invention to provide easy to use 2 pieces set which is quite convenient to use and make glasses accessible to driver all the time.

It is another object of the present invention to provide a new and improved method of storage which allows easy storage and eliminates the need for storage boxes and vehicles dashboard.

It is also the objective of invention to provide easily accessible storage placement of glasses which does not obstruct the vision in any area important to the driving of the automobile.

It is a further object of the present invention to provide a new and improved apparatus which is of a durable and reliable construction.

An even further object of the present invention is to provide a new and improved apparatus which is susceptible of a low cost of manufacture with regard to both materials and labor, and which accordingly is then susceptible of low prices of sale to the consuming public, thereby making such apparatus economically available to the buying public.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the front view of sunglass mount as per preferred embodiments of the invention.

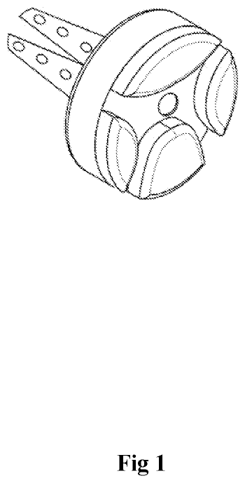

FIG. 2 shows the mount attached to sunglasses as per preferred embodiments of the invention.

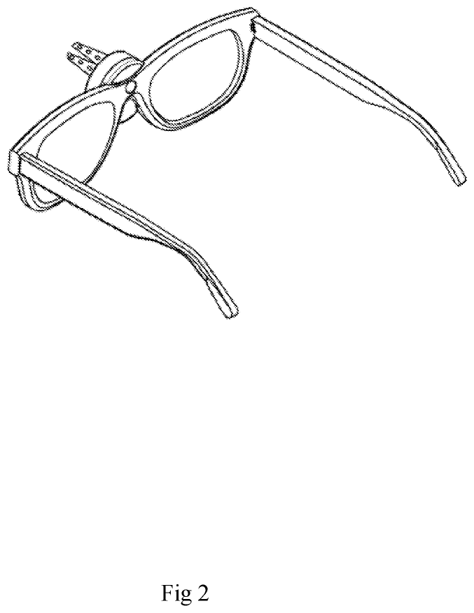

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

More specifically, the instant invention claims a method to store polarized sunglasses in any type of vehicle. The assembly as per its preferred embodiments allows glasses to be stored/mounted in any vehicle dashboard air vent grill using magnets on the bridge of the sunglass and a magnetic mount.

The proposed assembly as per its preferred embodiments comprises of two parts which come as a set that is being used together. A sunglass having a magnet placed onto or into its bridge, a car air vent grill coupled with one or more magnets installed onto or into it and the matching mold of the bridge of the sunglass onto the mount, the two will get attached together by the attraction force of the magnets, while having the mount on the air vent of any car make and model. This will allow the sunglasses to be easily stored inside the car without having a need for sunglass storage box. This eliminates any possible cause of damaging the sunglass.

The assembly as per its further embodiments is developed from high quality magnet which can vary in their sizes to support various types of glasses. The glasses with an add on magnet/metal are molded in the middle of main frame to provide enough magnetic force to remain attached to the AC vent grill of vehicle.

The second part which can also be magnet/metal can be attached to air vent grill allowing to attach with the other part resulting an effect and effective storage medium.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I. A vehicle glasses storage system comprising:
First part which is magnetic or metallic in nature is attached to the main frame;
A second part which is magnetic or metallic in nature and is attached to the vehicle's air-vent grill;
Both parts are attached together for stable and quick storage area for the glasses.

II. An advanced approach for storage of glasses which doesn't needs any additional space, is easy to store and always accessible to the driver. The proposed assembly allows an easy installation and can be used for any type of vehicle.
